(19) United States
(12) Patent Application Publication
(10) Pub. No.: US 2025/0380790 A1
(43) Pub. Date: Dec. 18, 2025

(54) ATTACHMENT DEVICE TO AN ANCHOR POINT AND METHOD FOR RELEASING ONE SUCH DEVICE

(71) Applicant: ZEDEL, Crolles (FR)

(72) Inventor: Simon EMONIN, Seyssinet Pariset (FR)

(73) Assignee: ZEDEL, Crolles (FR)

(21) Appl. No.: 19/196,025

(22) Filed: May 1, 2025

(30) Foreign Application Priority Data
Jun. 18, 2024 (FR) 2406524

(51) Int. Cl. A45F 3/14

(52) U.S. Cl. CPC A45F 3/14

(57) ABSTRACT

An attachment device includes a clamp for attachment to an anchor point. The clamp defines a closed position and an open position respectively preventing or allowing extraction from the anchor point. The clamp has a support defining a hole and a rigid tab installed movably with respect to the hole. A lock has a first part and a second part, the first part being secured to the second part or released from the second part to define a locked state or an unlocked state. The first part is attached to the rigid tab. In the locked position, the first part limits movement of the rigid tab to prevent a relative movement between the rigid tab and the support out of the closed position to keep the clamp in the closed position.

### BACKGROUND OF THE INVENTION

The invention relates to an attachment device configured for attaching to an anchor point and to a method for releasing one such device.

### Prior Art

In a large number of rope access activities, the rope access technician is working far above the ground and it may be difficult for him to move down to ground level or his attachment point. To avoid superfluous movements, the rope access technician is equipped with the equipment necessary for his safety and for him to be able to perform his work properly.

Exceptionally, the rope access technician may injure himself, which tends to complicate his movements and/or reduce the speed at which he can move. In the most dangerous situations, the rope access technician is unable to move. To ensure his safety as regards the most common injuries, the rope access technician is equipped with a first aid kit that has to be close at hand in case of an accident. Ideally, a first aid kit is fixed to the roping harness to avoid having to move along the rope to reach the first aid kit after the accident.

A trade-off has to be found between the ability of the first aid kit to remain attached to the roping harness when the harness rubs against rock faces or catches on branches and the ease with which the latter can be detached without jeopardising safety.

### Object of the Invention

One object of the invention consists in providing an attachment device that can be easily attached to an anchor point and that is easily detachable from the anchor point, while at the same time reducing the risk of losing the attachment device, and preferentially that is able to be released with a single hand while reducing the risk of losing the attachment device once the latter has been released.

This result tends to be achieved by means of an attachment device designed to be attached to an anchor point, the attachment device comprising:
a clamp configured to be attached to the anchor point, the clamp defining an open position and a closed position, the closed position preventing the anchor point from being extracted from the clamp and the open position allowing the anchor point to be extracted from the clamp, the clamp having a support defining a hole and a rigid tab installed movably with respect to the hole, the rigid tab being in the hole in the closed position and outside the hole in the open position, wherein in the closed position, the anchor point is designed to be located between the rigid tab and the support;
a lock defining a locked state and an unlocked state, the lock having a first part and a second part, the first part being attached to the second part or released from the second part to respectively define said locked and unlocked states;
   wherein the first part is attached to the rigid tab;
   wherein, in the locked position, the first part limits the movement of the rigid tab to prevent a relative movement between the rigid tab and the support out of the closed position to keep the clamp in the closed position;
   wherein the second part is connected to the rigid tab or fixed to the support;
   wherein in the unlocked position, the first part allows movement of the rigid tab out of the hole;
   wherein both the first part and the second part are securely attached to the support when the lock is in the unlocked position.

According to one feature of the invention, the support is connected to the rigid tab by a flexible member when the lock is in the unlocked position.

In advantageous manner, the flexible member is terminated at a first end by the first part and at a second end by the second part. In the locked position, the flexible member forms a flexible loop surrounding the support.

In a particular configuration, the attachment device to an anchor point comprises an adjustment buckle configured to adjust a length of the flexible member and to clamp the flexible member tightly around the support in the locked position.

In an advantageous development, in the locked position, the rigid tab is located between the support and the flexible loop.

Preferentially, the anchor point is designed to be located between an attachment wall of the support and the rigid tab. The attachment wall defines an edge. In the closed position, the rigid tab extends from the hole up to the edge.

According to one embodiment, the hole is a through hole. In the closed position, the rigid tab passes through the hole and protrudes out beyond the hole.

In an advantageous development, the anchor point is designed to be located between an attachment wall of the support and the rigid tab. The attachment wall defines an additional hole, the rigid tab passing through the additional hole in the closed position.

Preferentially, the support defines an openable enclosure irremovable from the hole.

In another advantageous development, the support has a plate and an openable enclosure fixed in removable manner to the plate, the openable enclosure being removable from the plate when the clamp is in the open position and irremovable from the plate when the clamp is in the closed position.

In preferential manner, the device for attaching an item of equipment to an anchor point comprises a roping harness, the anchor point being a strap attached to a belt or a thigh loop of the roping harness.

Advantageously, the openable enclosure is a first aid kit.

Preferentially, the rigid tab has a bended portion, the edge pressing on the bended portion when the flexible loop is in the closed position.

It is particularly advantageous to provide for the support to define an additional hole, the rigid tab entering the additional hole when the rigid tab is in the first position, the hole and the additional hole being aligned in a direction of sliding of the rigid tab between the closed position and the open position.

It is a further object of the invention to provide a method for releasing an attachment device that is simple to perform and preferentially with a single hand.

This result tends to be achieved by means of a method for releasing that comprises the following steps:
providing an attachment device according to any one of the foregoing configurations, the attachment device being attached to an anchor point;
opening the lock by acting on the first part to dissociate the first part and the second part, gripping being exerted on the first part;
pulling on the first part to move the rigid tab from the closed position to the open position and separate the attachment device and the anchor point.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of an attachment device attached to an anchor point, the clamp being in the closed position;

FIG. 2 schematically illustrates a side view of an attachment device attached to an anchor point, the clamp being in the closed position, the lock being in the unlocked position;

FIG. 3 schematically illustrates a perspective view of an attachment device attached to an anchor point, the clamp being in the open position;

FIG. 4 schematically illustrates a perspective view of an attachment device not attached to an anchor point, the clamp being in the open position and the lock being in the unlocked position;

FIG. 5 schematically illustrates a sectional view of an attachment device attached to the anchor point with the clamp in the closed position and the lock in the locked position and a flexible support surrounding the support;

FIG. 6 schematically illustrates a sectional view of an attachment device attached to the anchor point with the clamp in the closed position and the lock in the locked position;

FIG. 7 schematically illustrates a sectional view of an attachment device attached to the anchor point with the clamp in the closed position and the lock in the locked position, a flexible member being fixed to the first part;

FIG. 8 schematically illustrates a sectional view of an attachment device attached to the anchor point with the clamp in the closed position and the lock in the locked position, a clamping member being attached to the rigid tab;

FIG. 9 schematically illustrates a sectional view of another embodiment of an attachment device for attached to the anchor point with the clamp in the closed position and the lock in the locked position, a clamping member being attached to the rigid tab;

FIG. 10 schematically illustrates a roping harness provided with an annular part designed for securing an attachment device.

### DESCRIPTION OF THE EMBODIMENTS

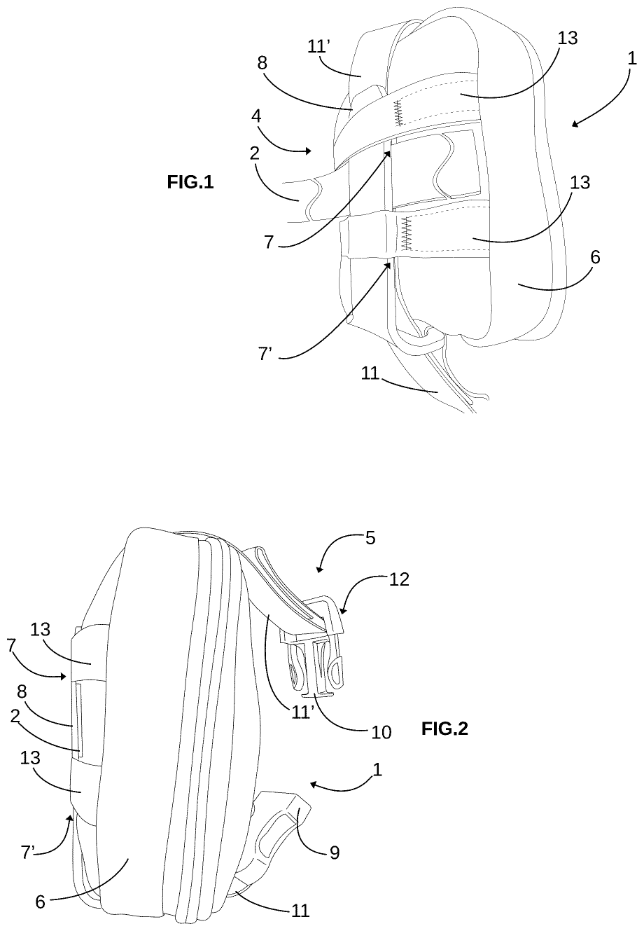

FIGS. 1 to 10 illustrate different embodiments of an attachment device 1 that is configured to be attached in removable manner to an anchor point 2, and a roping harness 3 having a wire element designed to form the anchor point 2. The wire element can be a strap, a rope, a braid, a cloth, a textile element or be made from any other suitable material.

In acrobatic activities, the roping harness 3 may be pressing against walls, branches or other salient elements that may apply an effort on the attachment device 1. To prevent the attachment device 1 from being accidentally detached from the anchor point 2, the attachment device 1 comprises a clamp 4 that is attached to the anchor point 2 and a lock 5 that enables or disables a change of state of the clamp 4.

It is sought to provide an attachment device 1 that ensures a solid and efficient fastening with the anchor point 2 while at the same time being easy to open when necessary.

The attachment device 1 comprises a clamp 4 that is configured to be fixed to the anchor point 2. The clamp 4 defines an open position and a closed position. The closed position prevents the anchor point 2 from being extracted from the clamp 4. The open position allows the anchor point 2 to be extracted from the clamp 4. The clamp 4 has a support 6 defining a hole 7 and a rigid tab 8 fitted movably with respect to the hole 7. In the closed position, the rigid tab 8 is in the hole 7. In the open position, the rigid tab 8 is outside the hole 7. In the closed position, the anchor point 2 is designed to be located between the rigid tab 8 and the support 6.

The attachment device 1 forms a ring that is openable, at least the movable part thereof being formed by the clamp 4.

The rigid tab 8 is fitted movably with respect to the support 6 so as to slide into or out of the hole 7. Advantageously, the sliding is a translation.

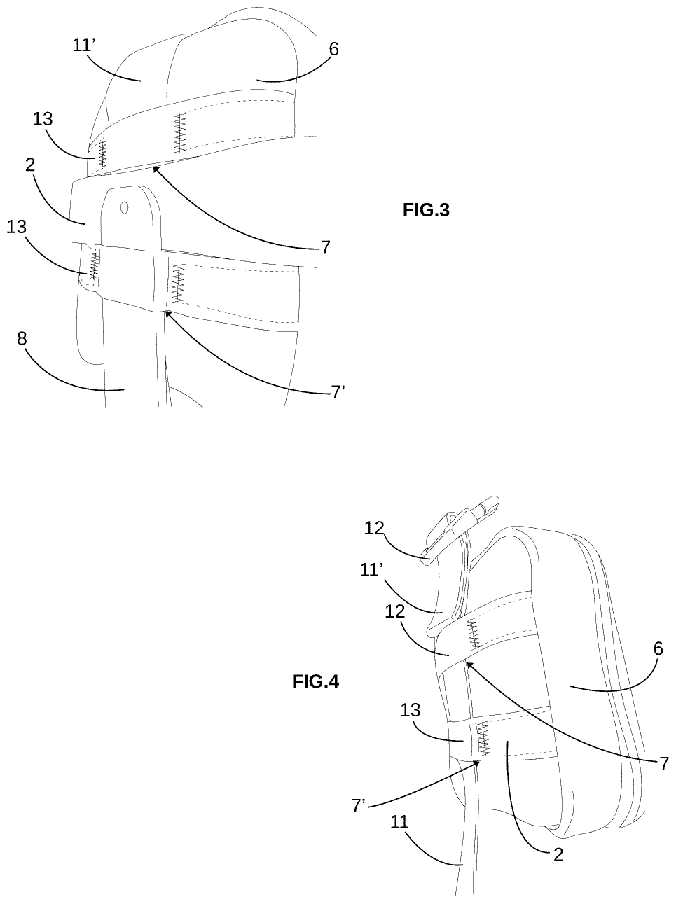

The clamp 4 presents a closed state illustrated in FIGS. 1, 2 and 5 to 9 and an open state illustrated in FIGS. 3 and 4.

The attachment device 1 also comprises a lock 5 defining a locked state and an unlocked state. To open the clamp 4, the lock 5 has to be toggled beforehand from the locked position to the unlocked position. The lock 5 generally comprises two parts that work in conjunction with one another to define a position where the two parts are fixedly secured to one another and a position where the two parts are free to move with respect to one another.

The lock 5 has a first part 9 that fixes to a second part 10 or detaches from the second part 10 to respectively define the locked state and the unlocked state. The first part 9 is connected to the rigid tab 8. The second part 10 is connected to the rigid tab 8 or fixed to the support 6. In the locked position, the lock 5 prevents a relative movement between the rigid tab 8 and the support 6 out of the closed position to keep the clamp 4 in the closed position, i.e. to keep the rigid tab 8 in the hole 7.

The lock 5 in the unlocked position enables the clamp 4 to move from the closed position to the open position allowing the rigid tab 8 to exit the hole 7. Both the first part 9 and the second part 10 are securely fixed to the support 6 when the lock 5 is in the unlocked position.

When the rope access technician is injured, it is commonplace for him to use one hand for his injury. Consequently, he only has one hand free to release and handle a first aid kit. It is therefore advantageous to provide an attachment device 1 associated with a first aid kit that is able to be freed with a single hand and that reduces the risks of the attachment device 1 being lost once the latter has been released from the anchor point 2. Once the attachment device 1 has been released from the anchor point 2, the first part 9 is fixed securely with the support 6, the second part is fixed securely with the support 6, and the rigid tongue 8 is fixed securely with the support 6.

Following his injury, the user will endeavour to reach the unlocked position using only his valid hand if this is the case. The user will therefore act on one or the other of the two parts. It is therefore important for both of the parts to be secured to the support 6 so that once the releasing action has been completed, the user who is holding either one of the two parts of the lock 5 is attached to the attachment device 1.

If the user only has one valid hand, it is advantageous for the release kinematics of the attachment device 1 to be simple. A sliding movement of the rigid tab 8 appears easy to achieve. However, for the same reasons as above, it is preferable for the user to keep the contact with the support 6 when unlocking the lock 5 and opening the clamp 4.

In a particularly advantageous embodiment illustrated in FIGS. 1 to 8, to make it easier to apply a force to open the clamp 4, a flexible member 11 is arranged between the rigid tab 8 and the first part 9. In this way, when the user is holding the first part 9, movement of the first part 9 to apply a force on the rigid tab 8 is accompanied by a deformation of the flexible member 11 to make the clamp 4 easier to open.

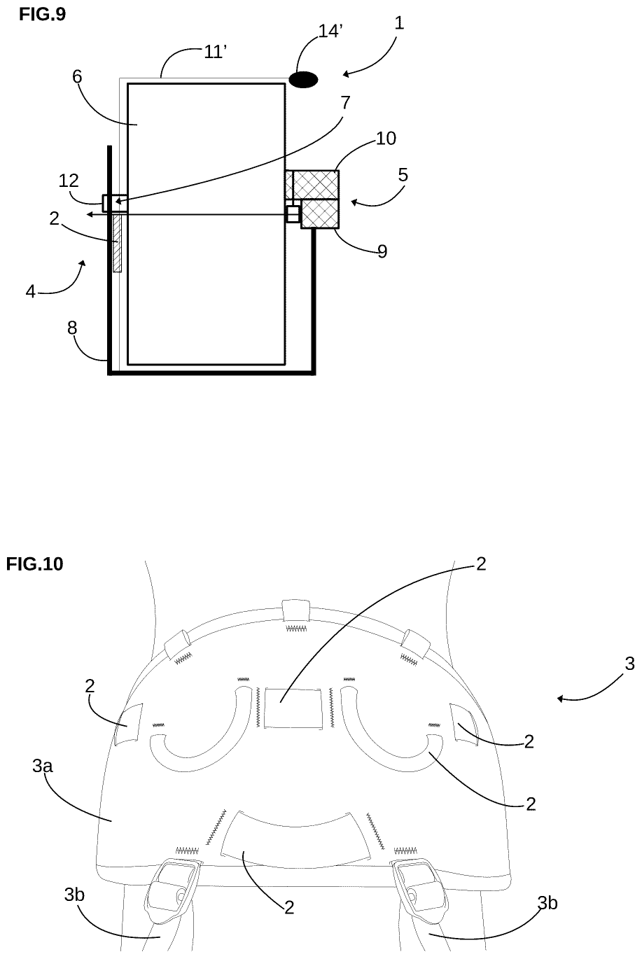

In an alternative embodiment illustrated in FIG. 9, the first part 9 is connected directly to the rigid tab 8.

The first part 9 can be connected to the support 6 by means of an additional flexible member, for example the same flexible member that connects the first part 9 to the rigid tab 8 and preferentially that extends the flexible member 11 beyond the connection or possibly the attachment between the flexible member 11 and the rigid tab 8.

It is particularly advantageous for the support 6 to define an openable enclosure, the openable enclosure being able to be irremovable from the support 6. One or more of the walls of the openable enclosure advantageously define the outer walls of the support 6. In an alternative, the support 6 is provided with a plate 6′ and an openable enclosure that is fixed removable from the plate 6′. The plate 6′ can be a standard plate and different types of openable enclosures can be fixed to the plate 6′ to adjust the volume of the openable enclosure to suit requirements. The openable enclosures can differ by their dimensions, their opening modes or other characteristics. A user who already has his openable enclosure can therefore fix the latter on the plate 6′. It is particularly advantageous for the openable enclosure to be irremovable from the plate 6′ when the clamp 4 is in the closed position. More preferentially, the openable enclosure is fixed to the plate 6′ by fastening means that are actuated independently from the clamp 4 to reduce the risks of losing the openable enclosure when the clamp 4 is in the open position. FIG. 8 illustrates an embodiment of a support 6 provided with a plate 6′ that is removable from the openable enclosure, but such an embodiment can be implemented for the other illustrated embodiments. Advantageously, the plate and openable enclosure are removable when the clamp 4 is in the openable position and more preferentially using other fastening members.

It is particularly advantageous for the first part 9 and/or the second part 10 to be fixedly secured to the openable enclosure without taking account of the fixing that exists between the openable enclosure and the plate 6′.

In an advantageous embodiment, when the lock 5 is in the unlocked position, the support 6 is connected to the rigid tab 8 by a flexible member 11. In the unlocked position, the flexible member 11 performs the securing between the rigid tab 8 and the support 6, thereby performing securing between the first part 9 and the support 6.

In a particularly advantageous embodiment, the flexible member 11 is terminated at a first end by the first part 9 and at a second end by the second part 10, in the locked position. The flexible member 11 forms a flexible loop that surrounds the support 6. The closer the flexible member 11 comes to the perimeter of the support 6, the more difficult it will become for the rigid tab 8 to move, which complicates or makes opening of the clamp 4 impossible. Preferentially, the flexible member 11 is associated with an adjustment buckle 12 configured to adjust the effective length of the flexible member 11 between the first part 9 and the second part 10, thereby making it possible to adapt to different or more or less full openable enclosures. This embodiment is particularly advantageous when the openable enclosure can be dissociated from the plate 6′ and/or when the openable enclosure has one or more flexible walls allowing deformation.

The larger the size of the rigid tab 8, the more difficult it is to move the latter to depart from the closed position when the flexible loop is closed. Advantageously, the anchor point 2 is designed to be located between an attachment wall of the support 6 and the rigid tab 8. The attachment wall defines an edge. In the closed position, the rigid tab 8 extends from the hole 7 up to the edge. The closer the shape of the flexible loop is to the shape of the support 6, the more difficult it is to move the rigid tab 8. When the flexible loop surrounds the support 6 in contact with the latter, accidental opening of the clamp 4 becomes very difficult even without a strong clamping force being applied. Securing of the closed position is all the more effective, the larger the length of the rigid tab 8.

The use of a flexible loop is particularly advantageous as it makes it easier to adapt to supports that may be associated with openable enclosures of varying shapes.

FIG. 10 illustrates an embodiment of a roping harness 3. The roping harness 3 comprises a belt 3a and a pair of leg loops 3b. The roping harness 3 has one or more wire elements that define one or more anchor points 2.

As illustrated in FIGS. 1 to 9, the support 6 is preferentially in the form of an openable enclosure, for example in the form of a kit and more preferentially in the form of a first aid kit. For example, the support 6 contains first aid material, advantageously at least one bandage, an antiseptic and possibly an adhesive tape. The support 6 then forms a first aid kit.

It is conceivable for the openable enclosure to receive equipment to be installed by the user other than the contents of a first aid kit. The openable enclosure is able to be opened, for example by means of a zip fastener or any other means enabling the openable enclosure to be opened to access its contents. The openable enclosure can define any shape, preferably a parallelepiped, and more preferentially a rectangular parallelepiped.

When the lock 5 is in the locked position, movement of the rigid tab 8 is all the more difficult as the length of the flexible member 11 approaches the value of the perimeter of the support 6 in a cutting plane where the support 6 forms a ring around the support 6. It is therefore advantageous to have a flexible member 11 that has a ratio between the length and the perimeter of the support 6 comprised between 1 and 1.5, preferably between 1 and 1.25 and more preferentially comprised between 1 and 1.1. It is possible to provide for the flexible member 11 to be provided with an adjustment buckle 12 configured to adjust the length of the flexible member 11. The closer the length of the flexible member 11 is to the perimeter of the support 6, the more friction there is at the edges of the support 6 covered by the flexible member 11. In more general manner, the attachment device can comprise means for adjusting a length of the flexible member 11 to clamp the flexible member 11 around the support 6 in the locked position.

As illustrated in FIGS. 1 to 4, it is advantageous to use a lock 5 in the form of a clip that can be actuated preferentially with one or two fingers. The first part 9 and the second part 10 preferentially have different shapes thereby enabling the user to differentiate the first part 9 and the second part 10 by touch. Another lock 5 is possible for example with a loop and a hook or a latching material.

To form the hole 7, it is advantageous for the support 6 to comprise a wire element 13 that is arranged salient to form a hoop receiving the rigid tab 8 in the closed position. The wire element 13 can be a flexible element, for example a rope, a strap, a braid or a fabric. The use of a wire element 13 facilitates deformation of the hoop when the rigid tab 8 is in the open position, thereby making detachment of the attachment device 1 with respect to the anchor point 2 easier to achieve.

In the particular embodiment illustrated in FIGS. 1 to 4, the support 6 has an additional hole 7′ and even more advantageously a hoop formed by a wire element 13 such as the one described in the above. The use of two hoops enables the position of the anchor point 2 to be imposed and the position of the rigid tab 8 to be better maintained.

In preferential manner and as illustrated in FIGS. 1, 2 and 5 to 8, the rigid tab 8 is bended. This rigidifies the rigid tab 8 and/or makes application of the forces aiming to shift the rigid tab 8 to the released position more complex when the flexible member 11 forms a flexible loop that is closed.

It will be more difficult for the rigid tab 8 to bend than the flexible member 11 to follow the change of orientation of the walls materialised by the edge. Furthermore, the more rigid the rigid tab 8, the more difficult translation will be for a given force applied on the flexible member 11. For example purposes, the rigid tab 8 can be formed by a layer of wood, metal, composite material or polymer material.

Preferentially, the rigid tab 8 is located between the flexible loop and the support 6 in order to limit the possibilities of movement of the rigid tab 8 and to introduce friction.

In a particular embodiment, the rigid tab 8 is arranged movable in translation only inside the slide defined by hole or holes 7 between the closed position and the open position. A movement that is only possible in translation makes accidental actuation of the rigid tab 8 more complicated.

By using a flexible member 11 that is attached to the rigid tab 8, a tractive force applied on the flexible member 11 results in movement of the rigid tab 8 between the closed position and the open position. According to the configurations, one end of the rigid tab 8 can be installed securely fixed to a portion of the wire element 13 or one end of the rigid tab 8 can be able to slide with respect to a portion of the wire element 13 only under certain conditions and in particular up to a threshold value. In this way, when the user is holding the first part 9 to open the lock 5, the tractive force applied on the flexible member 11 by pulling on the first part 9 results in the rigid tab 8 being moved to open the clamp 4. By continuing to pull on the first part 9, the support 6 is moved with respect to the anchor point 2 to release the attachment device 1.

As the rigid tab 8 is securely fixed to the flexible member 11 and the flexible member 11 is securely fixed to the support 6, the action performed by the user to open the clamp 4 ensures that when the attachment device 1 and the anchor point 2 become detached from one another, the user will be holding a part that is securely fixed to the attachment device 1. The risk of losing the attachment device 1 is very small or even non-existent.

To be able to act on the lock 5 and on the clamp 4 by exerting a force on the first part 9, different configurations are possible. FIGS. 1 to 5 illustrate an embodiment where the support 6 is surrounded by the flexible loop when the lock 5 is in the locked position. The first part 9 and the second part 10 are installed movable with respect to the support 6 in the unlocked position. The closer the perimeter of the flexible loop is to the perimeter of the support, the more difficult it is to move the flexible loop, thereby making movement of the rigid tab 8 more complicated. The deeper the rigid tab 8 is inserted in the hole 7 or protrudes out of the hole 7, the more difficult it is to depart from the closed position. This is particularly true when the rigid tab 8 extends from the hole 7 up to one edge of the support 6. The second part 10 can be used to prevent the support 6 and the flexible member 11 from coming detached from one another, for example by having a larger width than the width of an aperture passed through by the flexible member 11.

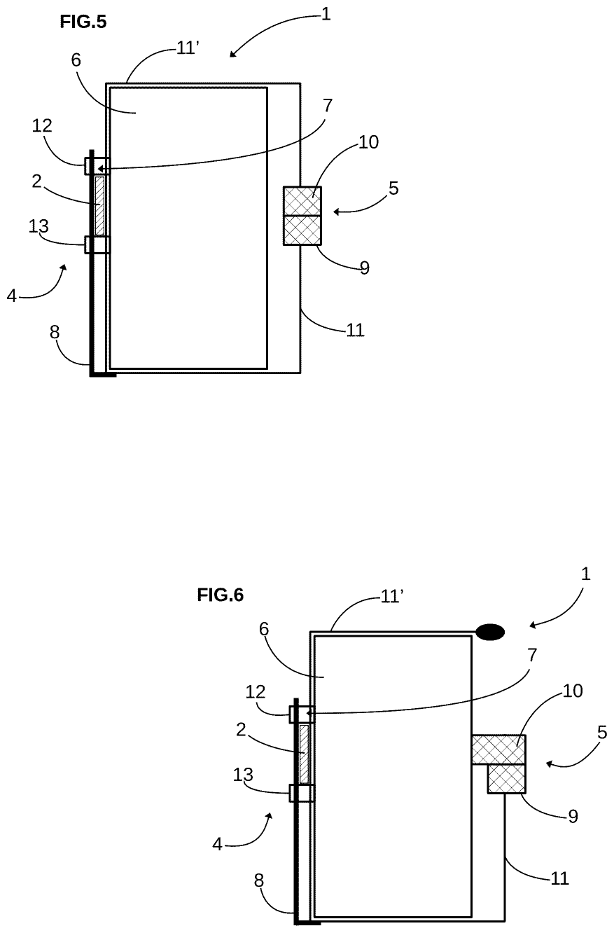

FIG. 6 illustrates another embodiment where the second part 10 is installed in fixed manner to the support 6. The flexible member 11 extends on the one hand up to the first part 9 and on the other hand up to an attachment zone designed to be fixed to the support 6. The attachment zone and the first part 9 limit the movements of the flexible member 11 thereby limiting the movements of the rigid tab 8 to prevent opening of the clamp 4. Once the first part 9 has been released from the second part 10, i.e. the lock 5 has been unlocked, a force applied on the first part 9 exerts a stress on the attachment zone which yields allowing the rigid tab 8 to move. The attachment zone can be used to prevent the support 6 and the flexible member 11 from detaching from one another.

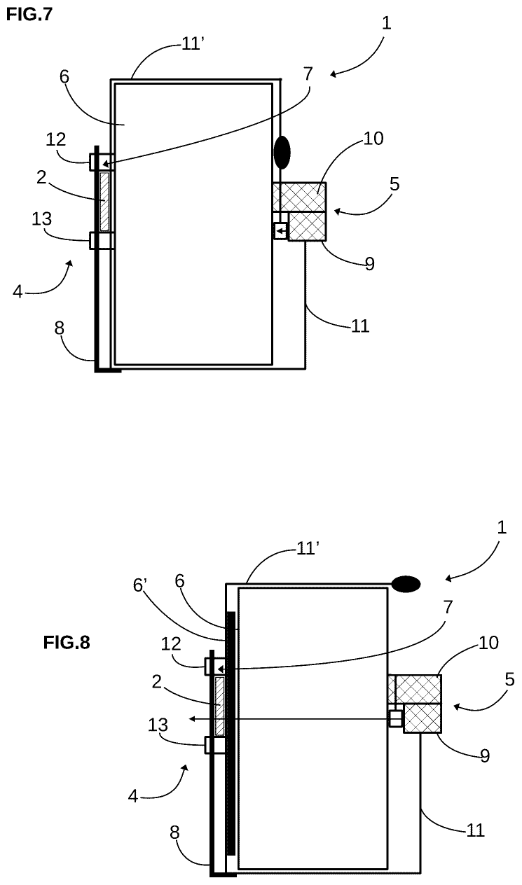

FIG. 7 illustrates another embodiment that corresponds to an alternative embodiment of FIG. 6 where the second end of the flexible member 11 is fixed to the first part 9 or to the second part 10 whereas the second part 10 is secured in fixed manner to the support 6. When the first part 9 detaches from the second part 10, the second end of the flexible member 11 becomes free to move. A force applied on the first part 9 to move the rigid tab 8 out of the hole 7 is not prevented by the second end of the flexible member 11. The connection between the second end and the first part 9 and/or the second part 10 can be a single-use connection indicating that the support 6 has been used.

FIG. 8 illustrates another alternative embodiment where the first part 9 and/or the second part 10 act directly on the rigid tab 8 to prevent or enable movement of the latter. When the first part 9 separates from the second part 10, blocking of the rigid tab 8 is eliminated. When the first part 9 detaches from the second part 10, the second end of the flexible member 11 becomes free to move. A force applied on the first part 9 to move the rigid tab 8 out of the hole 7 is not prevented by the second end of the flexible member 11. Blocking can be achieved by a wire element, for example a rope or a strap.

FIG. 9 illustrates yet another alternative embodiment where the rigid tab 8 extends continuously from the hole 7 up to the first part 9. Securing of the first part 9 with the second part 10 greatly limits movement of the rigid tab 8. This embodiment is less advantageous than the previous embodiment as the use of a rigid tab 8 that extends over several faces of the support 6 makes movement of the rigid tab 8 to slide from the closed position to the open position more complicated. Such a movement can be very complicated to achieve with a single hand, suspended in a roping harness 3 and being injured. The use of a flexible member 11 between the first part 9 and the rigid tab 8 means that the force to achieve sliding of the rigid tab 8 is better directed. Furthermore, it is advantageous to have a rigid tab 8 that has a single bend. More advantageously, the rigid tab 8 has a first part and a second part that are separated by a bend, the first part being longer than the second part. The first part is designed to be inserted in the hole 7. As illustrated in FIGS. 1, 2, 5, 6, 7 and 8, the flexible member 11 extends at least from the attachment wall to another wall of the support 6, circumventing the edge. The flexible member 11 limits displacement of the rigid tab 8 relative to the hole 7. The flexible member 11 passes through the rigid tab 8, which dictates the direction of movement relative to the support 6 and the anchor point. The tighter the flexible member 11 is in relation to the support 6, the more difficult it is to move the rigid tab 8. The rigid tab 8 is preferably “L”-shaped. The flexible member 11 circumvents the edge, thus locking the bended portion.

1. Attachment device to an anchor point comprising:
a clamp configured to be attached to the anchor point, the clamp defining an open position and a closed position, the closed position preventing extraction of the anchor point from the clamp and the open position allowing extraction of the anchor point from the clamp, the clamp having a support defining a hole and a rigid tab installed movably with respect to the hole, wherein when the clamp is in the closed position the rigid tab is in the hole and wherein when the clamp is in the open position the rigid tab is outside the hole, wherein when the clamp is in the closed position the anchor point is designed to be located between the rigid tab and the support;
a lock defining a locked state and an unlocked state, the lock having a first part and a second part, the first part being attached to the second part or released from the second part to respectively define said locked and unlocked states;
wherein the first part is attached to the rigid tab;
wherein, in the locked position, the first part limits movement of the rigid tab to prevent a relative movement between the rigid tab and the support out of the closed position to keep the clamp in the closed position;
wherein the second part is connected to the rigid tab or fixed to the support;
wherein when the lock is in the unlocked position, the first part allows movement of the rigid tab out of the hole;
wherein both the first part and the second part are securely attached to the support when the lock is in the unlocked position;
wherein the first part and the second part are securely fixed with the support after the attachment device has been released from the anchor point.

2. Attachment device to an anchor point according to claim 1 wherein the support is connected to the rigid tab by a flexible member when the lock is in the unlocked position.

3. Attachment device to an anchor point according to claim 2 wherein the flexible member is terminated at a first end by the first part and at a second end by the second part, and wherein in the locked position, the flexible member forms a flexible loop surrounding the support.

4. Attachment device to an anchor point according to claim 3 comprising an adjustment buckle configured to adjust a length of the flexible member to clamp the flexible member around the support in the locked position.

5. Attachment device to an anchor point according to claim 4 wherein in the locked position, the rigid tab is located between the support and the flexible loop.

6. Attachment device to an anchor point according to claim 2 wherein the anchor point is designed to be located between an attachment wall of the support and the rigid tab, wherein the attachment wall defines an edge and wherein in the closed position, the rigid tab extends from the hole up to the edge, and wherein the flexible element extends at least from the attachment wall to another wall of the support, circumventing the edge, the flexible member limiting a displacement of the rigid tab with respect to the hole.

7. Attachment device to an anchor point according to claim 1 wherein the hole is a though hole and wherein in the closed position, the rigid tab passes through the hole and protrudes out beyond the hole.

8. Attachment device to an anchor point according to claim 7 wherein the anchor point is designed to be located between an attachment wall of the support and the rigid tab, wherein the attachment wall defines an additional hole, the rigid tab passing through the additional hole in the closed position.

9. Attachment device to an anchor point according to claim 1 wherein the support defines an openable enclosure irremovable from the hole.

10. Attachment device to an anchor point according to claim 1 wherein the support has a plate and an openable enclosure fixed in removable manner to the plate, the openable enclosure being able to be removed from the plate when the clamp is in the open position and to be irremovable from the plate when the clamp is in the closed position.

11. Attachment device to an anchor point according to claim 9 wherein the openable enclosure is a first aid kit.

12. Attachment device to an anchor point according to claim 10 wherein the openable enclosure is a first aid kit.

13. Attachment device to an anchor point according to claim 1 comprising a roping harness, the anchor point being a strap attached to a belt or to a leg loop of the roping harness.

14. Attachment device to an anchor point according to claim 13 wherein the support is connected to the rigid tab by a flexible member when the lock is in the unlocked position after releasing the attachment device and the anchor point, wherein the rigid tab is “L” shaped and has a bended portion, the edge being pressing on the bended portion when the flexible loop is in the closed position, the flexible member circumventing the edge to press the bended portion against the edge.

15. Attachment device to an anchor point according to claim 1 wherein the support defines an additional hole, the rigid tab entering the additional hole when the rigid tab is in the first position, the hole and the additional hole being aligned in a direction of sliding of the rigid tab between the closed position and the open position.

16. Method for releasing an attachment device attached to an anchor point comprising the following steps:
providing an attachment device according to claim 1, the attachment device being attached to an anchor point;
opening the lock by acting on the first part to dissociate the first part and the second part, gripping being performed on the first part;
pulling on the first part to move the rigid tab from the closed position to the open position and separate the attachment device and the anchor point.
